(19) United States
(12) Patent Application Publication
(10) Pub. No.: US 2017/0053269 A1
(43) Pub. Date: Feb. 23, 2017

(54) Input number

(71) Applicant: Albert Roy Bingham, III, Swanton, VT (US)

(72) Inventor: Albert Roy Bingham, III, Swanton, VT (US)

(21) Appl. No.: 14/756,200

(22) Filed: Aug. 17, 2015

(51) Int. Cl. G06Q 20/38; G06Q 20/26; G06Q 20/10

(52) U.S. Cl. CPC G06Q 20/382; G06Q 20/102; G06Q 20/26

(57) ABSTRACT

This innovation, the “Input number”, is simply a second number assigned to a financial account that can only be used to credit deposits in that account. For example: an utility company may advertize an Input number to which all customers can direct their monthly payments, without the utility having knowledge of the customers various debit card account numbers. Eliminating computer security concerns for both parties

This new concept is for a number issued to a financial account, in addition to the usual “account number”, which can be used only to deposit or pay to that account. With the use of this number the actual account number of either party of a transaction need not be known to the other. As a result, information enabling withdrawal of funds by a party other than the owner will not be disclosed. The number can be any combination of letters, numbers, characters, or symbols assigned to any form of financial account and can be made public as no detrimental use can be made.

The most likely use for the practice would be in conjunction with a “debit card” from a specific issuer and could enable “bill paying” from the home computer to businesses and others having an account with the same issuer. At present a party must submit a card account number to the recipient who then performs the transaction. The flaw of this procedure is that the recipient or a third party may then use the divulged number to execute unauthorized transactions. A party who acts to transmit funds to another's input number can be made immune to any further exposure.

1. The greatly enhanced security of transactions executed using an input number, and not reveling other information, is the achievement of this innovation.
